(19) United States
(12) Patent Application Publication
(10) Pub. No.: US 2006/0194621 A1
(43) Pub. Date: Aug. 31, 2006

(54) Modular ear-piece/microphone that anchors voice communications

(76) Inventors: Nambirajan Seshadri, Irvine, CA (US); James D. Bennett, San Clemente, CA (US); Jeyhan Karaoguz, Irvine, CA (US)

Correspondence Address: GARLICK HARRISON & MARKISON, P.O. BOX 160727, AUSTIN, TX, 78716-0727, US

(21) Appl. No.: 11/120,765

(22) Filed: May 3, 2005

Related U.S. Application Data
(60) Provisional application No. 60/656,828, filed on Feb. 25, 2005.

(51) Int. Cl. H04M 1/00

(52) U.S. Cl. 455/569.1

(57) ABSTRACT

The present invention provides a wireless headset that anchors voice communications or calls to the wireless headset. This wireless headset includes wireless interface(s), and earpiece, a microphone, processing module, and a user interface. The wireless interface(s) wirelessly couples the wireless headset to a base station via a wireless personal area network (WPAN). The earpiece renders inbound portions of the service calls audible while the microphone is operable to produce the outbound portion of the call. Both the earpiece and microphone are communicatively coupled to the wireless interface(s). The processing module, also coupled to the wireless interface(s), allows the wireless headset to process the WPAN protocol stack and at least a portion of the servicing network protocol stack. This division allows the headset to anchor the call to the wireless headset.

### CROSS REFERENCES TO RELATED APPLICATIONS

This application claims the benefit of priority to U.S. Provisional patent application Ser. No. 60/656,828 entitled “MODULAR EARPIECE/MICROPHONE THAT ANCHORS VOICE COMMUNICATIONS,” by Nambirajan Seshadri, et al. filed on Feb. 25, 2005, and is incorporated herein by reference in its entirety for all purposes. This Application is related to the following applications: Application Ser. No. 10/981,418 entitled “UNIVERSAL WIRELESS MULTIMEDIA DEVICE,” by Nambirajan Seshadri, et al., filed on Nov. 4, 2004, which is a continuation-in-part of Application Ser. No. 10/856,430 entitled “PROVIDING A UNIVERSAL WIRELESS HEADSET,” by Nambirajan Seshadri, et al., filed May 28, 2004 which claims priority under 35 USC § 119(e) to Provisional Application Ser. No. 60/473,967 filed on May 28, 2003; and Application Ser. No. 10/981,418 is also a continuation-in-part of Application Ser. No. 10/856,124 filed May 28, 2004 which claims priority under 35 USC § 119(e) to Provisional Application Ser. No. 60/473,675 filed May 28, 2003; Application Ser. No. 10/976,300 entitled “MODULAR WIRELESS MULTIMEDIA DEVICE,” by Nambirajan Seshadri, et al., filed on Oct. 27, 2004, which is a continuation-in-part of Application Ser. No. 10/856,124 entitled “MODULAR WIRELESS HEADSET AND/OR HEADPHONES,” filed May 28, 2004 which claims priority under 35 USC § 119(e) to Provisional Application Ser. No. 60/473,675, filed on May 28, 2003; and Application Ser. No. 10/976,300 is also a continuation-in-part of Application Ser. No. 10/856,430 filed May 28, 2004 which claims priority under 35 USC § 119(e) to Provisional Application Ser. No. 60/473,967 filed May 28, 2003; Application Ser. No. ______ entitled “HANDOVER OF CALL SERVICED BY MODULAR EARPIECE/MICROPHONE BETWEEN SERVICING BASE PORTIONS,” by Nambirajan Seshadri, et al., filed on May 3, 2005, which claims priority under 35 USC § 119(e) to Provisional Application Ser. No. 60/653,234 filed on Feb. 15, 2005; Application Ser. No. ______ entitled “MODULAR EARPIECE/MICROPHONE (HEADSET) OPERABLE TO SERVICE VOICE ACTIVATED COMMANDS,” by Nambirajan Seshadri, et al., filed on May 3, 2005, which claims priority under 35 USC § 119(e) to Provisional Application Ser. No. 60/______ filed on Apr. 22, 2005; Application Ser. No. ______ entitled “BATTERY MANAGEMENT IN A MODULAR EARPIECE MICROPHONE COMBINATION,” by Nambirajan Seshadri, et al., filed on May 3, 2005, which claims priority under 35 USC § 119(e) to Provisional Application Ser. No. 60/646,270 filed on Jan. 24, 2005; Application Ser. No. ______ entitled “PAIRING MODULAR WIRELESS EARPIECE/MICROPHONE (HEADSET) TO A SERVICED BASE PORTION AND SUBSEQUENT ACCESS THERETO,” by Nambirajan Seshadri, et al., filed on May 3, 2005, which claims priority under 35 USC § 119(e) to Provisional Application Ser. No. 60/646,437 filed on Jan. 24, 2005; Application Ser. No. ______ entitled “MANAGING ACCESS OF MODULAR WIRELESS EARPIECE/MICROPHONE (HEADSET) TO PUBLIC/PRIVATE SERVICING BASE STATION,” by Nambirajan Seshadri, et al., filed on May 3, 2005, which claims priority under 35 USC § 119(e) to Provisional Application Ser. No. 60/646,235 filed on Jan. 24, 2005; Application Ser. No. ______ entitled “EARPIECE/MICROPHONE (HEADSET) SERVICING MULTIPLE INCOMING AUDIO STREAMS,” by Nambirajan Seshadri, et al., filed on May 3, 2005, which claims priority under 35 USC § 119(e) to Provisional Application Ser. No. 60/646,272 filed on Jan. 24, 2005; Application Ser. No. ______ entitled “INTEGRATED AND DETACHABLE WIRELESS HEADSET ELEMENT FOR CELLULAR/MOBILE/PORTABLE PHONES AND AUDIO PLAYBACK DEVICES,” by Josephus A. Van Engelen, et al., filed on May 3, 2005, which claims priority under 35 USC § 119(e) to Provisional Application Ser. No. 60/646,465 filed on Jan. 24, 2005, all of which are incorporated herein by reference in their entirety for all purposes.

### BACKGROUND OF THE INVENTION

1. Field of the Invention

This invention generally relates to wireless communications and more particularly to a modular wireless headset operable to anchor a call to the headset.

2. Background of the Invention

Wireless communications offer users the ability to be “wired” from almost anywhere in the world. Cellular telephones, satellite telephones, wireless local area networks, personal digital assistants (PDAs) with radio frequency (RF) interfaces, laptop computers with RF interfaces and other such devices enable these wireless communications. Such wireless communications have been extended to personal wireless networks, such as these defined by the Bluetooth specification. Not only have cellular telephones become very popular, but Wireless Local Area Networking (WLAN) devices have also proliferated. One standard for wireless networking, which has been widely accepted, is the Specification of the Bluetooth System, v. 1.0 (“Bluetooth Specification”).

The Bluetooth Specification enables the creation of small personal area networks (PAN's) where the typical operating range of a device is 100 meters or less. In a Bluetooth system, Bluetooth devices sharing a common channel sequence form a piconet. Two or more piconets co-located in the same area, with or without inter-piconet communications, is known as a scatternet.

The Bluetooth Specification supports voice communications between Bluetooth enabled devices. When a pair of Bluetooth devices supports voice communication, the voice communications must be wirelessly supported in a continuous fashion so that carried voice signals are of an acceptable quality. One popular use of personal wireless networks couples a wireless headset(s) with cellular telephone(s), personal computer(s), and laptop(s), etc. The Bluetooth Specification provides specific guidelines for providing such wireless headset functionality.

Bluetooth provides a headset profile that defines protocols and procedures for implementing a wireless headset to a device private network. Once configured, the headset functions as the device's audio input and output. As further defined by the Bluetooth Specification, the headset must be able to send AT (Attention) commands and receive resulting codes, such that the headset can initiate and terminate calls. The Bluetooth Specification also defines certain headset profile restrictions. These restrictions include an assumption that the ultimate headset is assumed to be the only use case active between the two devices. The transmission of audio is based on continuously variable slope delta (CVSD) modulation. The result is monophonic audio of a quality without perceived audio degradation. Only one audio connection at a time is supported between the headset and audio gateway. The audio gateway controls the synchronous connection orientated (SCO) link establishment and release. The headset directly connects and disconnects the internal audio stream upon SCO link establishment and release. Once the link is established, valid speech exists on the SCO link in both directions. The headset profile offers only basic inoperability such that the handling of multiple calls or enhanced call functions at the audio gateway is not supported. Another limitation relates to the manner which Bluetooth devices service only single channel audio communications. In most cases, the Bluetooth device is simply a replacement for a wired headset. Such a use of the Bluetooth device, while providing benefits in mobility of the user, provides little additional benefit over wired devices. Because other wireless solutions provide many of the benefits that current Bluetooth devices provide in servicing voice communications, the needs for the complexities of the Bluetooth Specification are questioned.

Thus, there is a need for improved operations by WLAN devices servicing audio or multimedia communications that provide additional user functionality and improved service quality.

### BRIEF SUMMARY OF THE INVENTION

Embodiments of the present invention are directed to systems and methods that are further described in the following description and claims. Advantages and features of embodiments of the present invention may become apparent from the description, accompanying drawings and claims.

### BRIEF DESCRIPTION OF THE SEVERAL VIEWS OF THE DRAWINGS

FIG. 1 is a diagram of a wireless headset in accordance with the present invention;

FIG. 2 is a diagram of another modular wireless headset in accordance with the present invention;

FIG. 3 is a diagram of a wireless headset operable to couple to various base stations in accordance with the present invention;

FIG. 4 is a schematic block diagram of a multi-channel wireless headset in accordance with the present invention;

FIG. 5 is a schematic block diagram of an access point in accordance with the present invention;

FIG. 6 is a graphic representation of a protocol stack and responsibilities associated with various layers within the protocol stack

FIG. 7 is a schematic block diagram of a wireless earpiece in accordance with the present invention;

FIG. 8 is a schematic block diagram of a wireless microphone in accordance with the present invention;

FIG. 9 is a schematic block diagram of a wireless earpiece in accordance with the present invention;

FIG. 10 is a schematic block diagram of a wireless microphone in accordance with the present invention; and

FIG. 11 is a logic diagram illustrating operation of a wireless device to service audio communications serviced by wireless headsets according to an embodiment of the present invention.

### DETAILED DESCRIPTION OF THE INVENTION

Embodiments of the present invention provide for the anchoring of calls or audio communications serviced by wireless headsets coupled to servicing base station(s) and servicing networks that substantially addresses the identified needs, as well as other needs. One embodiment provides a method to service calls to destination terminal accessed through a servicing network. This involves establishing a first wireless personal area network (WPAN) that communicatively couples a first base station and a wireless headset. The WPAN then communicatively couples to the servicing network through the first base station. This allows the servicing of calls with a first communication pathway between the destination terminal and the wireless headset via the communicatively coupled servicing network and first WPAN. The headset processes the entire protocol stack for the WPAN and the headset and base station share at the processing of the protocol stack associated with the servicing network. The wireless headset may for example support a number of upper layers of the servicing network protocol stack. In such an example, the base station supports a number of lower layers of the servicing network protocol stack. The processing of the servicing network protocol stack is thus divided between the wireless headset and the first base station. Additionally, a number of diverse protocol stacks, which will described in further detail, may be supported by the headset. A subscriber or system identification module (SIM) within the wireless headset may support or provide for SIM functionality for the first base station.

The wireless headset may detect a second base station where the second base station like the first base station supports a number of lower layers of the servicing network protocol stack. The presence of a second base station allows a second WPAN to be established wherein the second WPAN communicatively couples the second base station and the wireless headset. This allows the establishment of a second communication pathway from the headset to the destination terminal through the second WPAN and the servicing network. Once this second communication pathway has been established it is possible for the wireless headset to initiate a handoff of a serviced call from the first communication pathway to the second communication pathway. When the call has been switched to the second communication pathway the servicing of the call via the second communication pathway continues and the first communication pathway may be terminated.

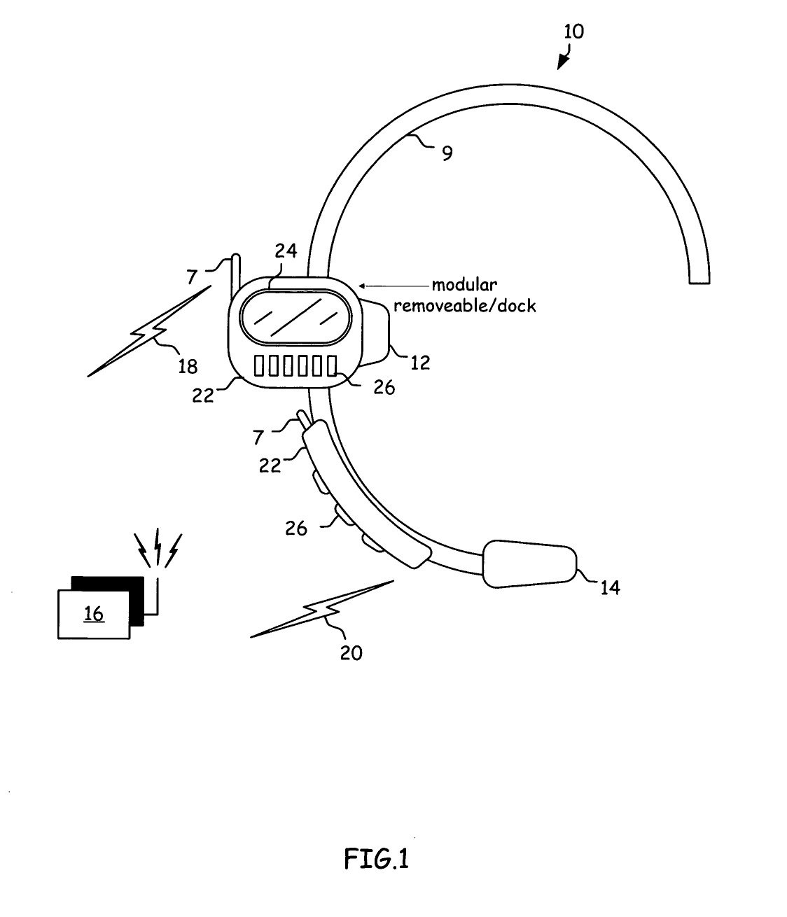

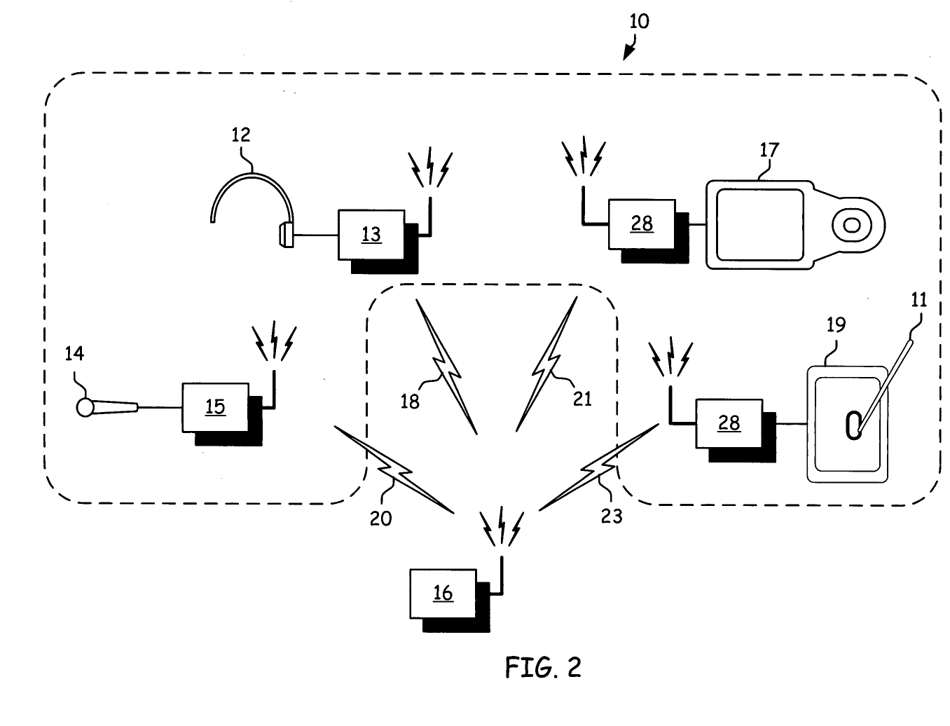

FIG. 1 is a diagram of a modular wireless headset 10 wirelessly coupled to a base station or host device 16 that includes earpiece 12 and microphone 14. Earpiece 12 may be a separate physical device from microphone 14. Accordingly, earpiece 12 and microphone 14 may be separate communication devices that individually communicate with base station 16 via separate communication pathways. As shown, earpiece 12 may communicate with base station 16, which may be a cellular telephone, wire line telephone, laptop computer, personal computer, personal digital assistant, etc., using transceiver (or receiver) 13 of FIG. 2 via a first communication pathway 18. Although shown as being external to earpiece 12, transceivers 13 and 15 may be integrated within earpiece 12 and microphone 14. Base station 16 is operable to establish a wireless pathway to earpiece 12 or microphone 14. The microphone 14 may communicate with the base station 16 using transceiver (or transmitter) 15 of FIG. 2 via a second communication pathway 20. Either or both earpiece 12 and microphone 14 may have a user interface 22. If the communication pathways are established in accordance with the Bluetooth specification, communication resources 18 and 20 may be different timeslot allocations on the same synchronous connection orientated (SCO) link, or may be separate SCO links.

User interface 22 allows a user to initiate enhanced call functions or network hardware operations. These enhanced call functions include call initiation operations, call conferencing operations, call forwarding operations, call hold operations, call muting operations, and call waiting operations. Additionally, user interface 22 allows the user to access network interface functions, hardware functions, base station interface functions, directory functions, caller ID functions, voice activated commands, playback commands and device programming functions. User interface 22 can be any combinations of a visual interface as evidenced by display 24, tactile interface as evidenced by buttons 26, and/or an audio interface. Each of these devices, earpiece 12, microphone 14 and base station 16, may support one or more versions of the Bluetooth Specification or other wireless protocols. A Bluetooth “scatternet” is formed from multiple “piconets” with overlapping coverage

A user of wireless headset 10 may establish communications with any available base station in a piconet. Wireless headset 10 may have a minimal user interface 22 where a single authenticate button 26 initiates joining of a piconet. Wireless headset 10 may reside within the service coverage area of each of multiple base stations. Thus, when wireless headset 10 enters (or powers up in) an area with more than one functioning piconets, a user may depress authenticate button 26, use a voice command or other means to start the authentication process. With the authenticate button depressed, the wireless headset attempts to establish a piconet with base station 16. Subsequent authentication operations are required to have the wireless headset join the selected piconet. These subsequent authentication operations may include prompting the user for selection of the piconet, requiring that an entry be previously made in an access list to allow wireless headset 10 to join the piconet, or other complete authentication operations. These operations may involve accessing information stored in memory within the headset. For example, SIM module information may be contained and used to authenticate with either or both the base station and servicing network.

Once wireless multimedia device or headset 10 joins a respective piconet, wireless multimedia device or headset 10 establishes an audio link with the base station via respective WLAN links. Such calls will be received and managed by base station 16 or multimedia device or headset 10. Management duties for the calls may be divided between base station 16 and multimedia device or headset 10. Processing of the protocol may be divided between the headset and base station. Integrated circuits in either headset 10 or base station 16 support the protocol stack.

FIG. 2 is a diagram of a modular wireless headset that includes an earpiece 12, a microphone 14, display/camera 17, and a portable touch-screen/whiteboard 19. Microphone 14, earpiece 12, display/camera 17 and portable touch-screen/whiteboard 19 may each be a separate physical device. In one embodiment earpiece 12 is a separate device from microphone 14, that together function to provide the optionally modular wireless headset shown in FIG. 1. Accordingly, earpiece 12, microphone 14, display/camera 17, and a portable touch-screen/whiteboard 19 are separate communication devices that may individually communicate with base stations via separate or shared communication pathways. A single communication pathway using time division may be used to communicate between earpiece 12, microphone 14, display/camera 17, portable touch-screen/whiteboard 19 and base stations 30-37 or access point 21. This communication may be secured by encryption, validation, or other like methods known to those skilled in the art and may support one-way or two-way audio, video or text communications. One way communications allow the devices to act as receivers to broadcast information, while two-way communications allow real-time audio or video communications such as phone or radio communications which may be augmented with data and text to support interactive net meetings.

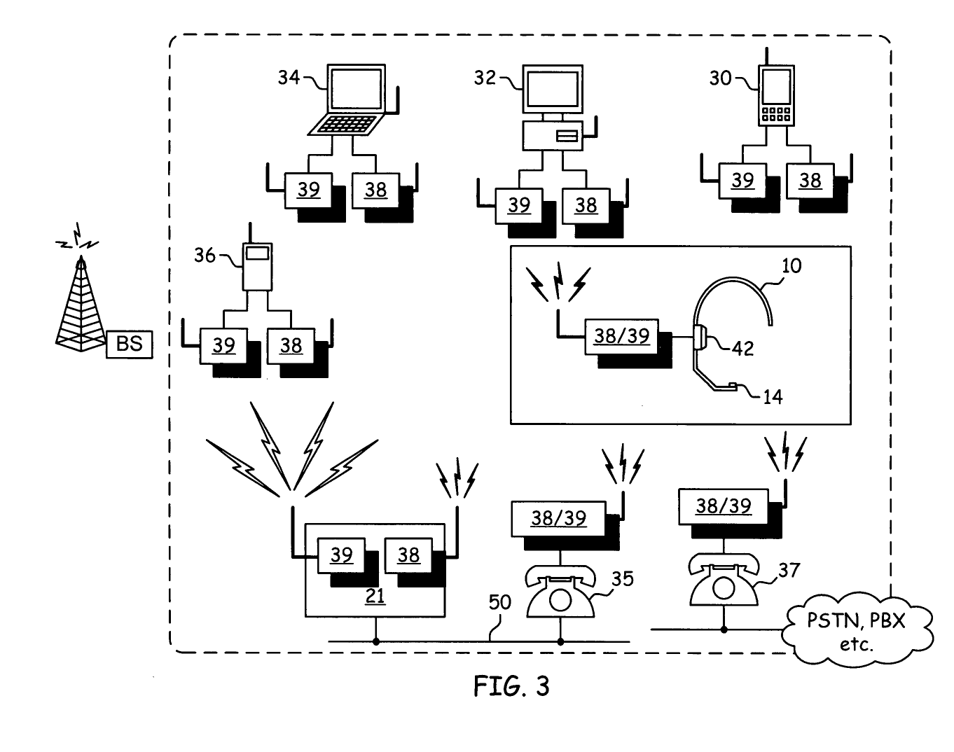

Earpiece 12, once authorized or validated, may communicate with base station 16, which FIG. 3 depicts as a cellular telephone, wire line telephone, Ethernet telephone, laptop computer, personal computer, personal digital assistant, etc, using transceiver (or receiver) 13 via a first communication pathway 18. Base station 16 is operable to establish a wireless pathway to earpiece 12 or microphone 14. The microphone 14, once authorized or validated, may communicate with the base station 16 using transceiver (or transmitter) 15 via a second communication pathway 20. Display/camera 17 and portable touch-screen/whiteboard 19 may communicate with the base station 16 using transceivers (or transmitters) 25 and 27 via communication pathways 21 and 23, respectively.

If the communication pathways are established in accordance with the Bluetooth specification, communication resources may be different timeslot allocations on the same synchronous connection orientated (SCO) link, or may be separate SCO links. Encryption, validation, pairing, or other like means may secure these communication pathways. Validation or pairing may prevent unauthorized devices from communicatively coupling to the base station.

The quality of data provided to these devices may be adjusted according to which devices are actually present and supported. For example, audio quality can be improved and may even support stereo. This option may limit resources provided to microphone 14, display/camera 17, or whiteboard 19 to service multi-channel audio. Another example may favor the use of only earphone 12 and display/camera 17 to view streamed video and audio content. To coordinate the presentation of both audio and video in such an example, the earphone 12 and display/camera 17 and their received communications may be synchronized to provide a quality viewing experience. Similarly, to coordinate the presentation of multiple audio channels, earphones 12 may be synchronized in order to provide a quality experience. To coordinate the presentation of real-time two-way audio earphones 12 and microphone 14 may be synchronized such that unacceptable delays do not exist within exchanged voice communications. This coordination ensures there is no undue delay between the presentations provided by these individual devices allowing the user to perceive a seamless presentation. This embodiment allows the multimedia device to support net-meetings that require the delivery of complete Internet conferencing solutions with multi-point data conferencing, text chat, whiteboard, and file transfer, as well as point-to-point audio and video. Additionally, this allows the multimedia device to coordinate the presentation of these different media formats without necessarily requiring shared physical connections of these devices.

Direct connectivity previously limited the physical structure that could be used for a wireless headset or multimedia devices that supports net-meetings. In many cases, this results in headsets or multimedia devices that are cumbersome to use and uncomfortable to wear. The protocol used between base stations, access points and other communicatively coupled devices may allow the base station or access point to send data to each device in a coordinated manner that allows for the synchronized presentation of multimedia content by the devices. For example, one embodiment may allocate a predetermined portion of each data transmission for each media format. This would allow base station 16 to transmit the same data to each device, wherein each device only processes that content intended for that device. In another embodiment, base station or access point communicates in parallel with each device. By coordinating the data or packets exchanged with the devices, their individual presentations may be synchronized.

Earpiece 12 and microphone 14 may have on-chip operations to support call conferencing, call waiting, flash, and other features associated with telephones or net-meetings. These functions may me accessed and reviewed by a user interface and display within the base station or a user interface and display located on or coupled to either earphone 12 or microphone 14. The user interface and display, located on or coupled to either the base station or earphone 12 or microphone 14 may have a display and button(s) that may be used to program device, perform directory functions including selecting number to call, view caller ID, initiate call waiting, or initiate call conferencing. Additionally, circuitry within earphone 12 or microphone 14 may enable voice-activated dialing. The actual voice recognition could be performed within earphone 12, microphone 14, or a base station. Thus, earphone 12 or microphone 14 may act to initiate calls and receive calls. A link between earphone 12 and microphone 14 would allow earphone 12 or microphone 14 to share resources, such as batter life, and allow earphone 12 or microphone 14 to be recharged from a base station.

Each of the devices 30-37 also includes piconet RF interface 38 and/or wireless interface 39. Piconet RF interface 38 may be constructed to support one or more versions of the Bluetooth specification. As such, each of the piconet RF interfaces 38-36 include a radio frequency transceiver that operates at 2.4 gigahertz and baseband processing for modulating and demodulating data that is transceived within a piconet. As such, universal wireless multimedia device 10 may be wirelessly coupled with any one of the devices 30-37 and act as the headset communicatively coupled to the devices 30-37.

Devices 30-37 may further include a wireless LAN (WLAN) RF interface 39. The wireless LAN RF interfaces 39 may be constructed in accordance with one or more versions of IEEE802.11 (a), (b), and/or (g) or other WLAN protocol known to those skilled in the art. Accordingly, each of the WLAN RF interfaces 39 include an RF transceiver that may operate in the 2.4 gigahertz range and/or in the 5.25 or 5.75 gigahertz range and further includes baseband processing to modulate and demodulate data that is transceived over the corresponding wireless communication link.

Contrasting the functionality of the piconet RF interfaces with the WLAN RF interfaces, the piconet RF interfaces allow point-to-point communication between the associated devices, while the WLAN RF interfaces enable the associated devices to communicate indirectly via access point 21. For example, via piconet RF interfaces 38 laptop 34 can communicate directly with cellular telephone 36. In contrast, via WLAN RF interfaces 39, laptop 34 communicates indirectly, via access point 21, with cellular telephone 36. In general, the coverage area of a piconet is significantly smaller than the coverage area of a WLAN. Thus, for example, if laptop 16 and cellular telephone 36 were unable to establish a piconet connection via piconet RF interfaces 38 due to distance between the devices, they would be able to establish a wireless communication link via the WLAN RF interfaces 39 and access point 21. Dual communication pathways would allow communications to be switched between these communication pathways, dependent on factors such as audio quality, signal strength, and available bandwidth.

Universal wireless headset 10 may establish a piconet with any one of the devices 30-37 or with access point 21, which includes WLAN RF interface 40 and piconet RF interface 38. As such, universal wireless headset 10 may function as the headset for wire line telephone 37, Ethernet telephone 35, personal digital assistant 30, personal computer 32, laptop computer 34 and/or cellular telephone 36 provided a piconet can be established with the device. In accordance with the present invention, if a piconet cannot be established with the particular device, an extended network may be created utilizing the WLAN connectivity and at least one corresponding piconet.

For example, if a communication is to be processed via wire line telephone 14 (i.e., the base station for this example), but headset 10 is at a distance such that a piconet cannot be established between their piconet RF interfaces 26 and 28. If headset 10 is in range to establish a piconet with cellular telephone 36, the piconet RF interfaces 36 and 28 of cellular telephone 36 and headset 10, respectively, would establish a piconet. With this piconet established, cellular telephone 36, via its WLAN RF interface 48, establishes a wireless connection with access point 21. Access point 21 then establishes a communication link with wire line telephone 14. Thus, a logical connection is established between universal wireless headset 37 and wire line telephone 37 via cellular telephone 36 and access point 21. Note that wire line telephone 37 may be directly coupled to LAN connection 50 or coupled to a private branch exchange, which in turn is coupled to access point 21. Accordingly, within a wireless geographic area, the range of universal wireless headset 10 may be extended utilizing the WLAN within the geographic area. As such, universal multimedia device or headset 10 extends the mobility of its user, extends the range of headset use and expands on headset functionality. Alternatively, universal wireless multimedia device 10 may establish a piconet with cell phone 36. This allows cell phone 36 to establish an alternate communication pathway for the communications serviced by wired phone 14. Then it is possible for the call serviced by telephone 37 or 35 to be “handed off” to cell phone 36.

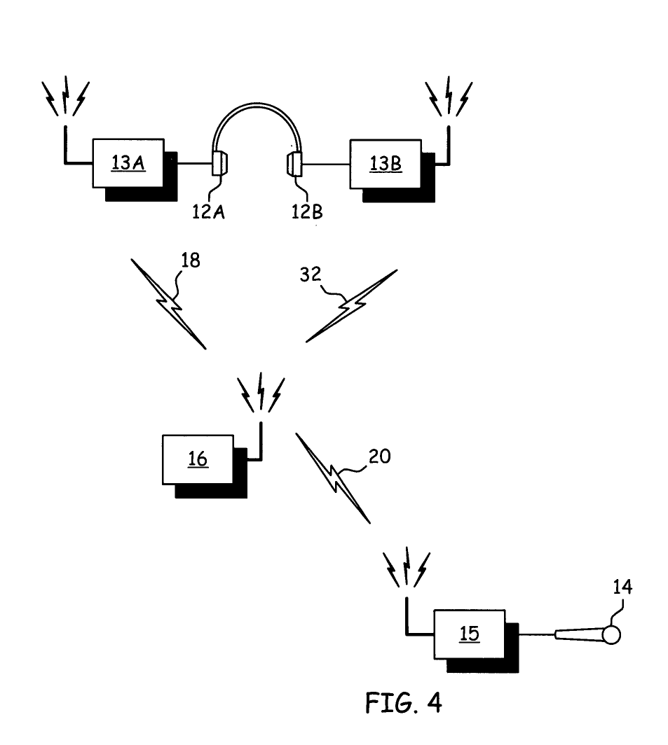

FIG. 4 is a diagram of another embodiment of a modular wireless headset 10 that includes two earpieces 12A and 12B, and microphone 14, and user interface 22. In this configuration, microphone 14 communicates with base station 16 via communication pathway 20, earpiece 12A communicates with base station 16 using transceiver (or receiver) 13A via communication pathway 18 and earpiece 12B communicates with base station 16 using transceiver (or receiver) 13B via communication pathway 32.

In operation, voice produced by the individual using microphone 14 is received via microphone 34 and converted into RF signals by circuitry within microphone 14. These RF signals are provided to base station 16 via communication pathway 20. Base station 16 includes a corresponding receiver antenna 34 and receiver module 36 to recapture the audio signals received via communication pathways 18, 20 and 32. In addition, base station 16 includes at least one transmitter 38 to transmit audio information to the earpiece(s) 12A and 12B. In one embodiment, base station 16 may transmit left channel stereo information to earpiece 12 and right channel stereo information to earpiece 12B.

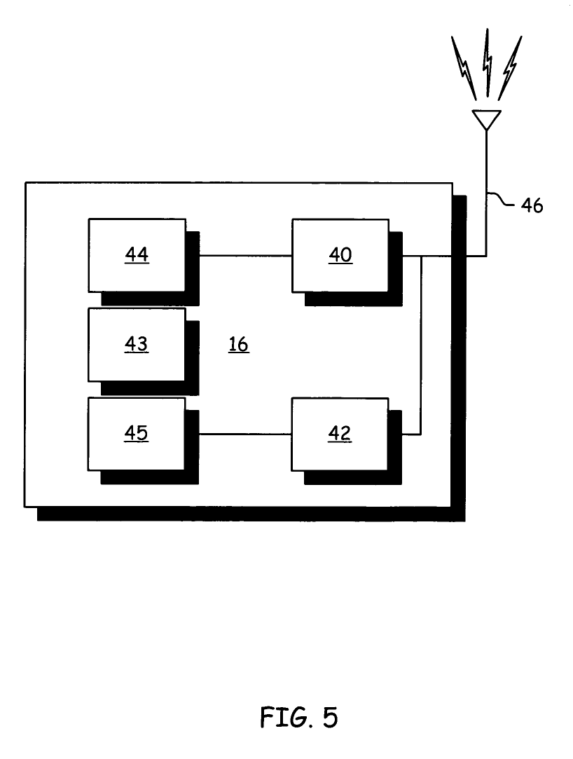

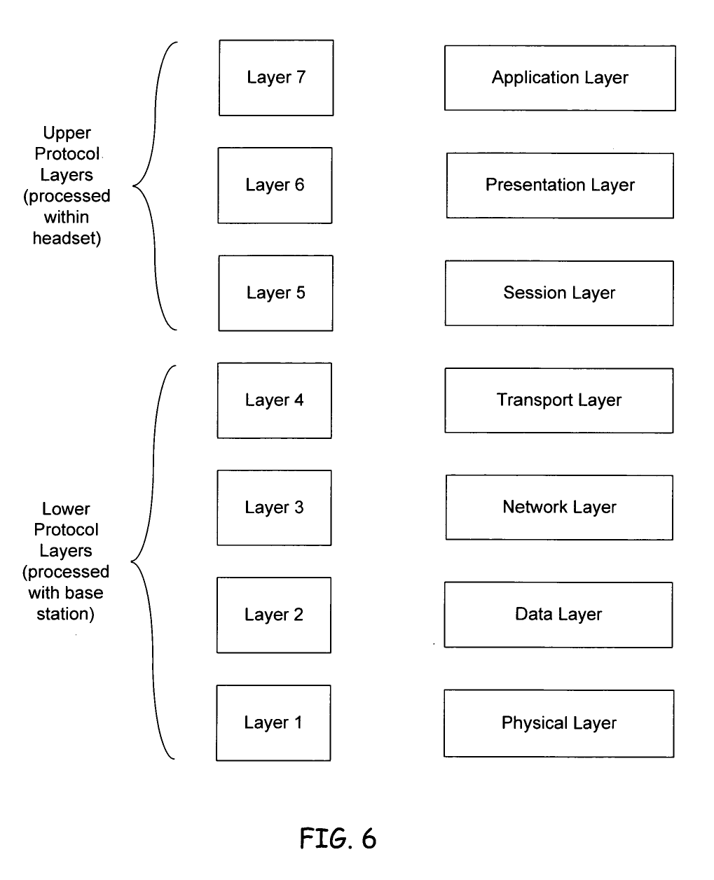

Wireless headphone(s) may be realized by omitting microphone 14 and including either one or both of earpieces 12A and 12B. In this embodiment, base station may be a playback device such as a CD player, DVD player, cassette player, etc. operable to stream audio information. If the display of FIG. 2 is utilized as well, the user may enjoy both streaming audio and video. FIG. 5 is a diagram of base station that supports modular wireless headsets. Base station 16 includes a combination of transmitter and receiver (or transceiver) modules that accept and modulate or demodulate streamed audio, video, text, or data to and from earpiece(s) 12 and microphone 14, display 17 and whiteboard 19 through antenna 46. The base station may be incorporated within or operably couple to another device such as a playback device, laptop, cellular telephone, land based telephone or other like device known to those skilled in the art. When coupling the headset to a servicing network, the base station may share the execution of the various protocol layers with the headset. This will be described in more detail with respect to FIG. 6. One embodiment has transmitter module 40, receiver module 42, and processing module 43. Transmitter module 40 accepts unmodulated streamed audio, video, data or text from playback type device 44 (e.g., DVD player, MP3 player, CD player, cassette player, or other like devices known to those skilled in the art). Playback device 44 may be integrated within base station 16. Transmitter module 40 then modulates the streamed audio into low intermediate frequency (IF) signal. In the case where two earpieces are employed, multiple transmitter modules or time separation may be employed to modulate the streamed audio into low IF signals for the earpieces for each channel (i.e. left and right channels of stereo transmissions. These multiple signals are synchronized in their presentation to a user. Similarly, receiver module 42 accepts modulated streamed audio, video, data or text from headset 10. Receiver module 42 recovers signals from the received low IF signals. The recovered signals are then relayed to receiving presentation device 45. Note that the generation of low IF signals and subsequent demodulation to recapture audio signal may be done in accordance with a particular wireless communication standard. For example, the Bluetooth specification may be used, IEEE802.11 (a), (b), and/or (g) may also be used, etc. when base station 16 couples to a telephone network (PSTN, cellular, satellite, WLAN, VOIP, etc.). Base station 16 may receive data associated with the command as well. For example, caller ID information may be passed to user interface 22 or enhanced call operations may be initiated based on input received at the user interface. Processing module 43 is operable to process at least a portion of the protocol layers of a servicing network protocol stack associated with a servicing network operably coupled to the base station. Additionally, the base station may use a subscriber identification module (SIM) within the coupled headset to facilitate the connection with the servicing network.

FIG. 6 depicts various protocol layers within the Open System Interconnect (OSI) model. This protocol stack is a particular software implementation of computer networking protocol suites. The stack is often thought of the software implementation of the protocols. Individual protocols are designed with a single purpose in mind. This modularization makes design and evaluation easier. Within embodiments of the present invention, this modularization allows functionalities to be split between various components of the headset and host device or base station. The OSI model is divided into seven layers, with layers of 1 to 4 often being referred to as the lower layers, and layers 5 to 7 being referred to as the upper layers. The embodiments of the present invention may divide the processing and execution of the layers between different modules. For example, the upper layers, 5 through 7, may be executed within the headset 10, while the lower layers, 1 through 4, are processed within a base station or host device. The base station or host device may use SIM information supplied by the headset to establish connections over available networks.

As shown, layer one is the physical layer. Layer 1 defines the hardware implementation and electrical implementation of the bus, network cabling, connector type, pin out, physical data rates, etc. Examples of the physical layer specification include the RS232 and the RS422 specification. Data units at this layer are called bits. Layer 2 is the data layer. Different network and protocol characteristics are defined by different data-link layer specifications. The data- link layer is subdivided into the media access control (MAC) that controls accessing code data into valid signaling formats for the physical layer and the logical link control (LLC), which provides the link to the network layer. Here, the data units are called frames. Layer 3, the network layer, provides address assignments and packet forwarding methods. Data at this layer is often referred to as packets. Layer 4 is the transport layer, which provides transfer correctness, data recovery, and flow control, for example. TCP is a layer for protocol and the protocol data units are called segments in the transport layer. Again, Layers 1 through 4 are often referred to as the lower protocol layers.

Layers 5, 6 and 7 are the upper protocol layers. Layer 5 is the session layer that is responsible for establishing communications sessions, security, and authentication. For example, NetBIOS is a layer 5 protocol. Protocol data units within the session layer are called data. Layer 6 is a presentation layer and determines how the device will represent the data. Again, data at this layer is referred to as data. Layer 7 is the application layer that allows user in the computer systems to generate and interpret data. Layer 7 also may provide for encryption and decryption. Applications using the network learn how to send a request, how to specify a filename, and how to respond to a request. Again, the headset may perform these upper layers, while the base station performs the lower layers. In this case, the upper layers will also provide for the handoff between a base station executing the lower protocol layers and a second base station, also executing the lower protocol layers. Although the OSI model was described the division of responsibilities may be divided within other protocol stacks known to those having skill in the art, such as but not limited to the SS7 protocol stack.

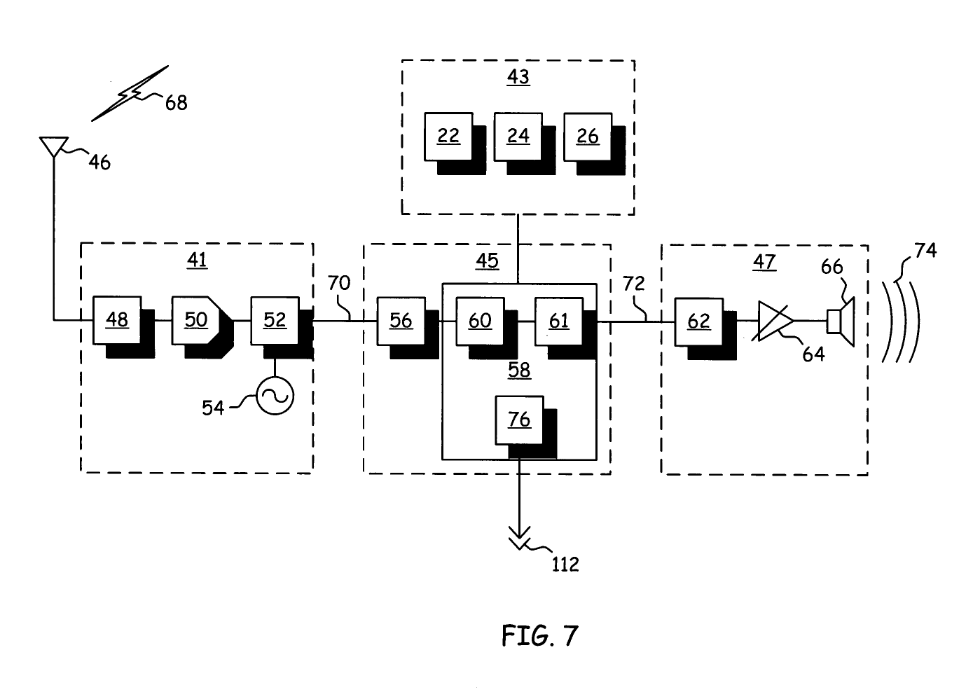

FIG. 7 is a schematic block diagram of earpiece 12. Earpiece 12 includes receiver module 41, optional user interface 43, data recovery module 45 and speaker module 47. One embodiment of receiver module 40 includes antenna 46, bandpass filter 48, low noise amplifier 50, down converter 52 and local oscillator 54. User interface 43 can be any combinations of a visual interface as evidenced by display 22, tactile interface as evidenced by buttons 26, and/or an audio interface represented by microphone/speaker and may operably couple to processing module 58 operable to process portions of the protocol stack of FIG. 6.

Data recovery module 45 may include an analog-to-digital converter (ADC) 56 and processing module 58. Processing module 58, which may have associated memory, is configured to provide digital channel filter 60, demodulator 61 and setup module 76. Additionally, processing module 58 may process the upper protocol layers. Speaker module 47 includes a digital-to-analog converter (DAC) 62, variable gain module 64, and at least one speaker 66.

Once the piconet is configured (which will be described subsequently), receiver module 41 receives inbound RF signal 68 from base station 16 via antenna 46. Bandpass filter 48 filters the received RF signal 68 which are subsequently amplified by low noise amplifier 50. Down converter 52 converts the filtered and gained RF signal 68 into low intermediate frequency (IF) signal 70 based on a local oscillator 54. Low IF signals 70 may have a carrier frequency at DC ranging to a few megahertz.

Data recovery module 45 receives low IF signals 70 and converts the low IF signals 70 into digital signals via ADC 56. Processing module 58 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory (not shown) may be a single memory device or a plurality of memory devices. Such a memory device may be a read-only memory, random access memory, volatile memory, non-volatile memory, static memory, dynamic memory, flash memory, and/or any device that stores digital information. Note that when processing module 58 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

Digital channel filter 60 receives the digital low IF signals 72 and filters these signals. Demodulator 61 recovers audio signals 74 from the filtered low IF signals. Note that the generation of RF signal 68 and subsequent demodulation to recapture audio signal 74 may be done in accordance with a particular wireless communication standard. For example, the Bluetooth specification may be used; IEEE802.11 (a), (b), and/or (g) may also be used, etc.

Speaker module 47 converts digital audio signal 74 into analog signals provided to the user through speakers 66. Adjustable gain module 64 adjusts the gain (i.e., adjusts volume), and provides the gained signals to speaker 66, which produces audible signals 74. As long as the piconet remains in place between earpiece 12 and base station 16, earpiece 12 will produce audible signals 74 from received inbound RF signal 68.

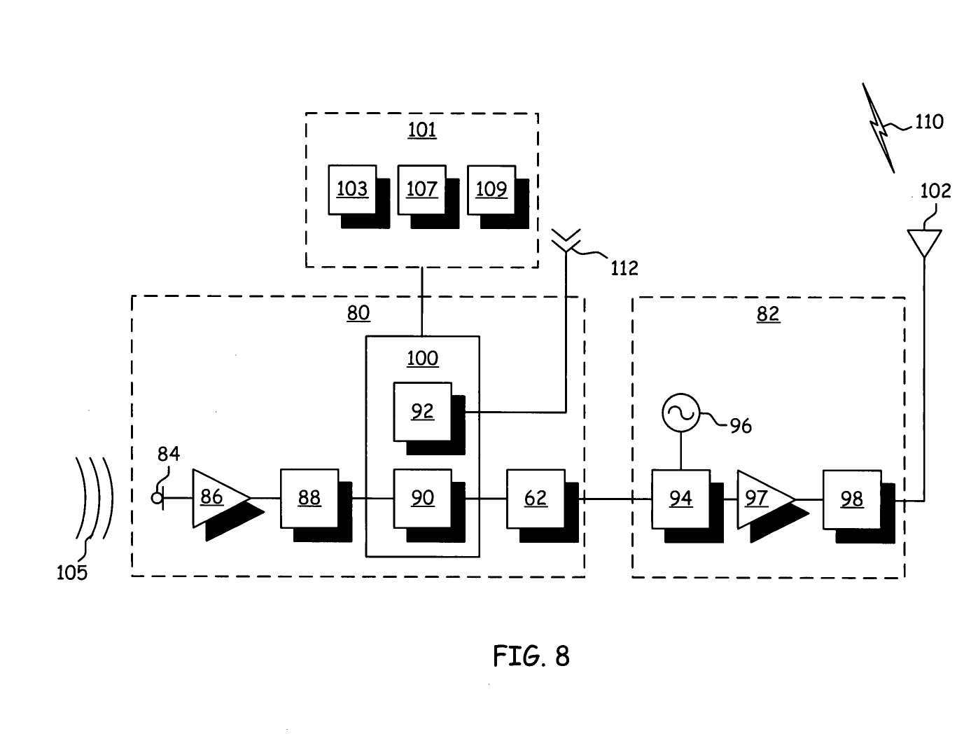

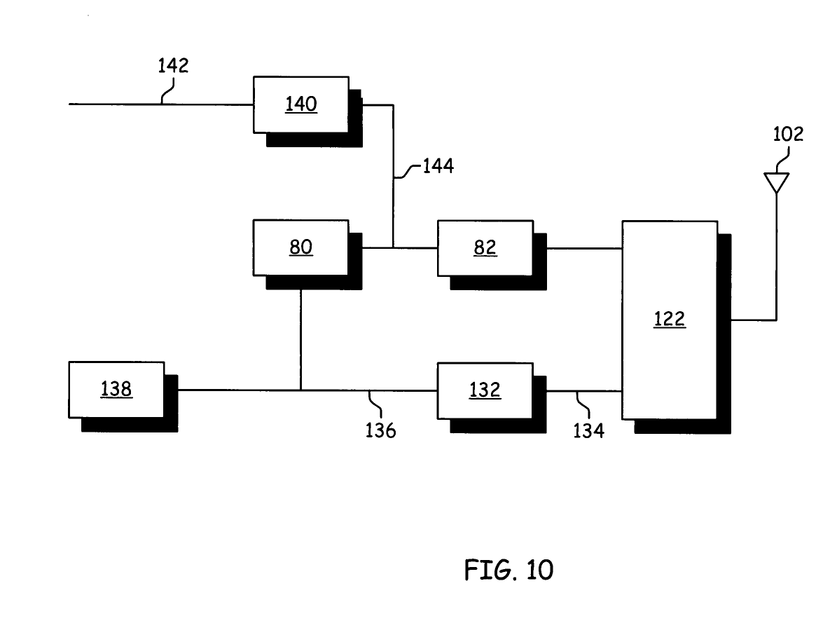

FIG. 8 is a schematic block diagram of microphone 14 that includes audio input module 80, transmitter module 82 and user interface 101. Audio input module 80 includes microphone 84, amplifier 86, ADC 88, processing module 100 that is configured to provide a setup module 92 and modulator 90, and DAC 62. Additionally, processing module 100, like processing module 58, may handle the entire WPAN protocol stack and all or a portion of the servicing network protocol stack. User interface 101 can be any combinations of a visual interface as evidenced by display 103, tactile interface as evidenced by buttons 107, and/or an audio interface represented by microphone/speaker 109 and may operably couple to processing module 100 to initiate enhanced call functions which will be described further in FIG. 10. Transmitter module 82 includes up-converter 94, local oscillator 96, power amplifier 97, bandpass filter 98, and antenna 102.

Once microphone 14 is configured within a piconet, microphone 84 is operably coupled to receive audio signals 105 and convert these signals to analog signals 106. Amplifier 86 amplifies analog audio signals 106 to produce amplified signals. ADC 88 then converts the amplified signals into digital audio signals 108. Modulator 90 modulates the digital signals based on a communication standard into modulated signals. As shown, modulator 90 and setup module 92 are implemented within processing module 100. Processing module 100 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when processing module 100 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

Up-converter 94 converts modulated signals 110 into RF signals based on local oscillator 96. Power amplifier 97 amplifies these signals, which may be subsequently bandpass filter 98. The filtered RF signals are then transmitted via antenna 102 as outbound RF signals 110 to base station 16. As long as the piconet is established to include microphone 14 and base station 16, microphone 14 will transmit to base station 16 in the manner just described.

As shown in both FIGS. 7 and 8, separable connector 112 may couple setup modules 76 and 92. Such a physical connection allows for earpiece 12 and microphone 14 to communicate in both directions with the base station to establish the piconet. For example, if the devices are compliant with one or more versions of the Bluetooth Specification, base station 16, functioning as the master, may issue a piconet request to earpiece 12 coupled to microphone 14. Upon receiving this request, earpiece 12 and microphone 14 respond to the request indicating that a receive RF channel (communication pathway 18) be setup for the earpiece and a transmit RF channel (communication pathway 20) be setup for microphone 14. Based on these responses, the master coordinates the establishment of the piconet and provides synchronization information through earpiece 12 and microphone 14 via receiver module 40 of earpiece 12. Setup modules 76 and 92 coordinate the synchronization of earpiece 12 and microphone 14 with the base station, as well as coordinating timeslot assignments and/or SCO link assignments. Once the piconet has been established in this manner, the connection between earpiece 12 and microphone may be secured to establish the earpiece 12 and microphone 14 as separate pieces.

As an alternative setup mode, earpiece 12, microphone 14 may be directly coupled to the base station. The direct coupling may be used to establish the piconet and exchange synchronization information, timeslot allocation information, etc. Once the information has been exchanged in this manner, the connections may be broken such that earpiece 12, microphone 14 and base station 16 are physically separate devices.

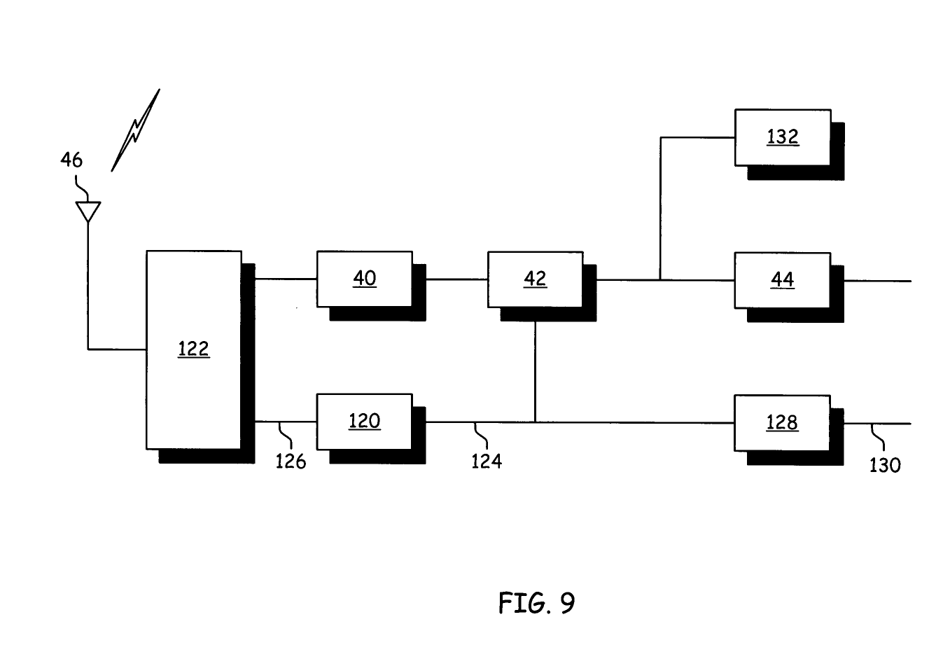

FIGS. 8 and 9 illustrate schematic block diagrams of earpiece 12 and microphone 14 that include transceiver modules (i.e., receiver modules and transmitter modules). The use of the transceiver modules allow earpiece 12, microphone 14 and base station 16 to be physically separate devices and be configured using the piconet's RF communications. As such,. earpiece 12 and microphone 14 may be continuously worn on a person for receiving incoming calls and/or placing outgoing calls.

Earpiece 12, as shown in FIG. 9, includes antenna 46, transmit/receive switch 122, receiver module 41, data recovery module 45, speaker module 47, transmitter module 120, input module 128 and display module 132. Receiver module 41, data recovery module 45 and speaker module 47 operate as discussed with reference to FIG. 6. Data recovery module 45 may produce display information that is provided to display module 132. For instance, the received RF signal may include display information such as caller ID, command information, etc. which is separated by data recovery module 45 and provided to display module 132, which may be an LCD display, plasma display, etc.

Input module 128, which may be a keypad, touch screen, voice recognition circuit, or other like user interfaces, receives user commands and produces digital command messages 124 there from. Such digital command messages 124 includes, but are not limited to, packet size, synchronization information, frequency hopping initiation information, timeslot allocation information, link establishment information, piconet address information, fast-forward, play, pause, volume adjust, record, stop and rewind.

Data recovery module 45 receives digital command messages 124 and, when applicable, processes the command messages. For example, if the command message is with respect to a volume adjust; a graphical representation of adjusting the volume may be presented on display module 132 and the gain of amplifier 64 adjusted to adjust the volume associated with speaker 66. Additionally module 45 like processing module 100 and processing module 58, may handle all or a portion of the servicing network and WPAN protocol stack(s).

Transmit module 120 receives digital command messages 124 and converts these messages into outbound RF command signals 126, which are subsequently transmitted to base station 16 and/or microphone module via antenna 46. Accordingly, by including transmitter module 120 along with receiver module 41, earpiece 12 may function as a master and/or slave within the piconet and exchange data with the other elements within the piconet.

FIG. 10 is a schematic block diagram of microphone 14 that includes audio input module 80, transmitter module 82, transmit receive switch 122, antenna 102, receiver module 132, input module 140 and display module 138. Input module 140 is operable to receive user input commands 142 and convert these commands into digital command messages 144. Input module 140 couples to or includes, a user interface that allows a user to initiate enhanced call functions or network hardware operations. These enhanced call functions include call initiation operations, call conferencing operations, call forwarding operations, call hold operations, call muting operations, and call waiting operations. Additionally, the user may access network interface functions, base station interface functions, directory functions, caller ID functions, voice activated commands and device programming functions. This user interface can be any combinations of visual interface(s), tactile interface(s), and/or an audio interface(s) that allow the user to input commands 142. Digital command messages 144 may be similar to digital command messages 124 and may further include establish a call, terminate a call, call waiting, or other like functions. Transmitter module 82 converts digital command messages 144 into RF command signals 134 that are transmitted via antenna 102. Similarly, inbound RF command signals 135 may be received by receiver module 132 via antenna 102. Display module 138, which may be a LCD display, plasma display, etc., receives digital command messages 136 and may display corresponding configuration messages. In addition, any display information received from the host and/or microphone module regarding setup, operation, or as part of the data content, may be displayed on display module 138. Additionally, processing module within microphone 14 may handle all or a portion of the servicing network and WPAN protocol stack(s).

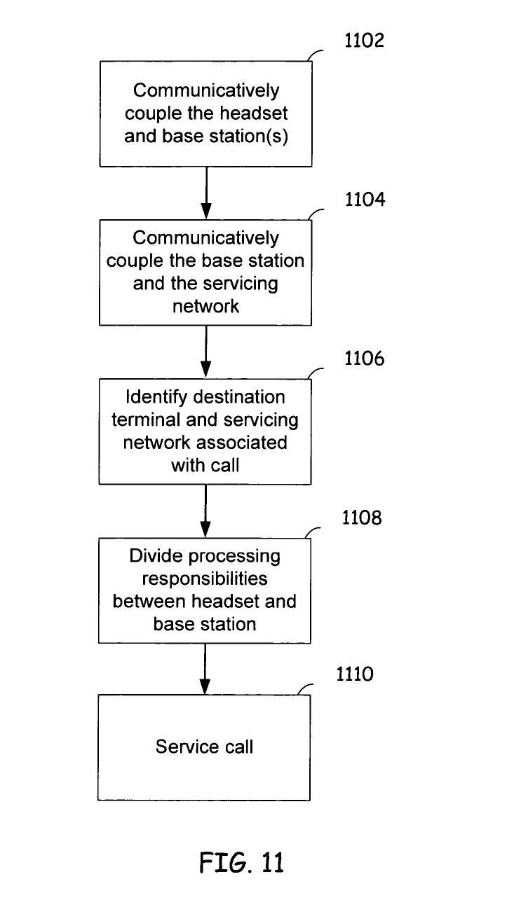

FIG. 11 is a logic diagram illustrating operation of a wireless headset constructed according to the present invention in managing call servicing. The operations described with reference to FIG. 11 may be performed whole or in part by an on-chip processor within or coupled to processing modules 58 and 100 of FIGS. 7 and 8. During normal operations, the wireless headset services normal operations, e.g., single call or device playback. Other modular devices, such as those of FIG. 2 that couple to the microphone or headset, may perform these operations.

FIG. 11 depicts one method to service calls anchored to the headset. Step 1102 establishes a WPAN that operably couples a base station(s) and the wireless headset. The headset can process the entire protocol stack associated with the WPAN connection. The base station allows the WPAN to be coupled to the servicing network(s) in step 1104. Where more than one servicing network is available, it is necessary to determine which servicing network is to be used to process the call. Unlike traditional headset, which served merely as an earpiece and microphone, the headset may share the processing of the protocol stack associated with the servicing network in step 1108 with the base station. One embodiment processes the upper layers within the headset and lower layers within the base station as described with reference to FIG. 6. Additionally, in servicing the call in step 1110, the headset may initiate call control functions between the wireless headset and a servicing network. The headset may also support SIM functionality when establishing or servicing the call. This allows the wireless headset to serve as a surrogate SIM for the first base station when initiating or servicing calls via the first base station.

Returning to step 1106, several servicing networks may be available. These networks include cellular network, public switched telephone network (PSTN), wide area network (WAN), local area network (LAN), and a wireless local area network (WLAN). Each of these may involve differing protocol stacks. The headset may support more than one protocol stack and may even support the handoff from one servicing network to another servicing network.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The preceding discussion has presented a modular communication device, modular wireless multimedia device and modular wireless headphones. By physically separating the microphone from the earpiece and/or by separating the earpieces, more discrete components may be produced that are more comfortable to wear and are less cumbersome to use. As one of average skill in the art will appreciate, other embodiments may be derived from the teaching of the present invention without deviating from the scope of the claims.

What is claimed is:

1. A wireless headset operable to service a call wherein the wireless headset comprises:
at least one wireless interface operable to wirelessly couple the wireless headset and at least one base station via a wireless personal area network (WPAN);
an earpiece communicatively coupled to the at least one wireless interface, wherein the earpiece renders an inbound portion of the call audible;
a microphone communicatively coupled to the at least one wireless interface, wherein the microphone is operable to produce an outbound portion of the call;
a processing module communicatively coupled to the at least one wireless interface, wherein the processing module is operable to:
process protocol layers of the WPAN;
process at least a portion of the protocol layers of a servicing network protocol stack associated with a servicing network operably coupled to the at least one base station;
initiate call control functions between the wireless headset and the servicing network operably coupled to the at least one base station;
service the call and call control functions; and
anchor the call to the wireless headset; and
a user interface communicatively coupled to the processing module, wherein the processing module is operable to initiate commands and/or call control functions based upon user input.

2. The wireless headset of claim 1, further comprising a subscriber identification module (SIM) operably coupled to the processing module, wherein the SIM is operable to support SIM functionality.

3. The wireless headset of claim 2, wherein the processing module is operable to validate the identity of the at least one first base station using the SIM functionality when establishing a call.

4. The wireless headset of claim 2, wherein the SIM of the wireless headset acts as a surrogate SIM for the first base station when initiating or servicing calls via the at least one base station.

5. The wireless headset of claim 1, wherein the at least one base station is operable to couple the wireless headset to a servicing network selected from the group consisting of:
cellular network;
public switched telephone network (PSTN);
wide area network (WAN);
local area network (LAN); and
a wireless local area network (WLAN).

6. The wireless headset of claim 1, wherein the at least one base station further comprises a servicing network interface, wherein:
the processing module supports a first portion of a servicing network protocol stack; and
the servicing network interface supports a second portion of the servicing network protocol stack.

7. The wireless headset of claim 6, wherein:
the processing module supports upper layer(s) of the servicing network protocol stack; and
the servicing network interface of the at least one base station supports lower layer(s) of the servicing network protocol stack.

8. The wireless headset of claim 1, wherein the user interface supports advanced call functions.

9. The wireless headset of claim 1, wherein the user interface comprises a visual interface, tactile interface, and/or audio interface.

10. The wireless headset of claim 9, wherein:
the tactile interface comprises one-touch buttons operable to initiate the advanced call functions; and
the audio interface further comprises a voice recognition system (VRS) operable to recognize voice commands, and wherein the processing module is operable to implement the VRS.

11. A method to service a call between a destination terminal accessible by a servicing network, and a wireless headset, wherein the method comprises:
establishing a wireless personal area network (WPAN), wherein the WPAN operably couples a first base station and the wireless headset;
operably coupling the WPAN to the servicing network with the first base station;
identifying the destination terminal associated with the call, wherein the destination terminal is accessible by the servicing network;
establishing a communications pathway between the destination terminal and the wireless headset, wherein the communication pathway comprises the operably coupled WPAN and servicing network, and wherein the wireless headset is operable to:
process protocol layers of the WPAN;
process at least a portion of the protocol layers of a servicing network protocol stack associated with a servicing network operably coupled to the at least one base station;
initiate call control functions between the wireless headset and a servicing network operably coupled to the first base station;
service the call and call control functions; and
anchor the call to the wireless headset;
servicing the call and call control functions; and
terminating the communication pathway when the call is terminated.

12. The method of claim 10, wherein the wireless headset is further operable to support subscriber identification module (SIM) functionality.

13. The method of claim 12, wherein the wireless headset is further operable to validate the identity of the first base station using the SIM functionality when establishing or servicing the call.

14. The method of claim 12, wherein the SIM functionality of the wireless headset acts as a surrogate SIM for the first base station when initiating or servicing calls via the first base station.

15. The method of claim 11, wherein the servicing network selected from the group consisting of:
cellular network;
public switched telephone network (PSTN);
wide area network (WAN);
local area network (LAN); and
a wireless local area network (WLAN).

16. The method of claim 1 1, wherein:
the wireless headset is further operable to:
support all of a WPAN protocol stack; and
support upper layer(s) of the servicing network protocol stack; and
the first base station further is operable to support lower layer(s) of the servicing network protocol stack.

17. The method of claim 11, wherein the wireless headset further comprises a subscriber identification module (SIM) operably to support SIM functions for the first base station.

18. The method of claim 11, wherein the wireless headset further comprises a user interface operable to support advanced call functions.

19. A modular wireless headset operable to service a call, wherein the modular wireless headset comprises:
a modular wireless earpiece operable to communicatively couple to base station(s) via a wireless personal area network (WPAN), wherein the earpiece renders an inbound portion of the call audible;
a modular wireless microphone operable to communicatively couple to the at least one base station via the WPAN, wherein the microphone is operable to produce an outbound portion of the call;
a processing module communicatively coupled to the modular wireless earpiece and/or modular wireless microphone, wherein the processing module is operable to:
process protocol layers of the WPAN;
process at least a portion of the protocol layers of a servicing network protocol stack associated with a servicing network operably coupled to the at least one base station;
initiate call control functions between the wireless headset and a servicing network operably coupled to the at least one base station;
service the call and call control functions; and
anchor the calls to the wireless headset; and
a subscriber identification module (SIM) operably coupled to the processing module, wherein the SIM is operable to support SIM functionality, and wherein the wireless headset is operable to support SIM functions for the base station(s);
a user interface communicatively coupled to the processing module, wherein the processing module is operable to initiate commands and/or call control functions based upon user input.

20. The modular wireless headset of claim 19, wherein the processing module is operable to validate the identity of the first base station using the SIM functionality when establishing a call.

21. The modular wireless headset of claim 19, wherein the SIM of the wireless headset acts as a surrogate SIM for the first base station when initiating or servicing calls via the first base station.

22. The modular wireless headset of claim 19, wherein the first base station further comprises a cellular network interface, wherein the cellular network interface supports a portion of the servicing network protocol stack.

23. The modular wireless headset of claim 19, wherein:
the processing module supports the entire WPAN protocol stack;
the processing module supports upper layer(s) of the servicing network protocol stack; and
the cellular network interface of the first base station supports a plurality of lower layers of the cellular network protocol stack.
